(19) United States
(12) Patent Application Publication
(10) Pub. No.: US 2020/0349204 A1
(43) Pub. Date: Nov. 5, 2020

(54) PATENT EVALUATION AND DETERMINATION METHOD, PATENT EVALUATION AND DETERMINATION DEVICE, AND PATENT EVALUATION AND DETERMINATION PROGRAM

(71) Applicant: AI Samurai Inc., Tokyo (JP)

(72) Inventors: Hajime Shirasaka, Tokyo (JP); Takashi Mikami, Tokyo (JP)

(21) Appl. No.: 16/320,684

(22) PCT Filed: Jul. 31, 2018
(86) PCT No.: PCT/JP2018/028760

§ 371 Date: Jan. 25, 2019

(51) Int. Cl. G06F 16/951; G06F 40/211; G06Q 50/18

(52) U.S. Cl. CPC G06F 16/951; G06Q 50/184; G06F 40/211

(57) ABSTRACT

A patent evaluation and determination method includes: an invention input step of receiving an input of an invention sentence relating to an invention; a keyword extraction step of performing a syntactic analysis on the input invention sentence in units of words, and then extracting any search keyword in the invention sentence; a patent sentence group extraction step of extracting a patent sentence group in which the search keyword is contained from a database using the extracted search keyword; and a determination step of comparing the invention sentence and a sentence included in the patent sentence group and determining the patentability of the invention sentence on the basis of a result obtained by multiplying a reciprocal number of an edit distance of the sentence included in the patent sentence group by a length index of the invention sentence and a content rate of the search keyword.

### TECHNICAL FIELD

This disclosure relates to a patent evaluation and determination method, a patent evaluation and determination device, and a patent evaluation and determination program.

### BACKGROUND

Various simulations have become possible with the evolution of information processing techniques. That is, since it has become easy to acquire high-performance information processing terminals, complex algorithms have been able to be inexpensively processed by a lot of people.

Since a patent incurs a lot of costs from its application to the acquisition of rights, a prior art search can be executed before application, but this also incurs costs. Consequently, there is a technique to determine the patentability of a patented invention or the like in one simulation. For example, Japanese Unexamined Patent Application Publication No. 2009-238074 discloses that, when a morpheme that appears at a predetermined ratio or more in a morpheme group included in claim 1 of patent application A is also contained in the specification of another patent application B, patent application B is determined to be similar to patent application A. In addition, Japanese Unexamined Patent Application Publication No. 2009-238074 discloses that it is also possible to determine similarity after assigning an importance to each morpheme as in a term frequency (TF)-inverse document frequency (IDF) method.

However, as described above, in Japanese Unexamined Patent Application Publication No. 2009-238074, since a search for whether words contained in the claims of a patent to be evaluated are contained in the entire specification of another patent application is performed, it is not possible to analyze which sentence the words are used in. That is, even if the meaning is entirely different from the meaning represented in the patent to be evaluated, the patents are determined to be similar simply because they contain the same words.

Thus, there is a need to provide a patent evaluation and determination method, a patent evaluation and determination device, and a patent evaluation and determination program that make it possible to determine whether patent literature similar to a patent (invention) to be evaluated is publicly known with a higher level of accuracy.

### SUMMARY

We thus provide a patent evaluation and determination method including: an invention input step of receiving an input of an invention sentence relating to an invention; a keyword extraction step of performing a syntactic analysis on the input invention sentence in units of words, and then extracting any search keyword in the invention sentence; a patent sentence group extraction step of extracting a patent sentence group in which the search keyword is contained from a database using the extracted search keyword; and a determination step of comparing the invention sentence and a sentence included in the patent sentence group and determining patentability of the invention sentence, wherein the determination step includes determining the patentability of the invention sentence on the basis of a result obtained by multiplying a reciprocal number of an edit distance of the sentence included in the patent sentence group by a length index of the invention sentence and a content rate of the search keyword.

The determination step may include determining the patentability of the invention sentence on the basis of an edit distance between the invention sentence and the sentence included in the patent sentence group.

The determination step may include dividing the invention sentence into components, and then determining the patentability of the invention sentence on the basis of an edit distance from the sentence included in the patent sentence group for each of the divided components.

The patent sentence group extraction step may include extracting patent classifications imparted to the patent sentence group, selecting a high-level patent classification having a large number of extractions from among the extracted patent classifications, and extracting the patent sentence group again using the search keyword and the selected high-level patent classification.

The patent sentence group extraction step may include extracting a result narrowed down to a patent group approximate to the search keyword in a distributed representation space, as the patent sentence group, from the search keyword and the patent sentence group obtained using the selected high-level patent classification.

The determination step may include determining the patentability of the invention sentence by comparing the invention sentence and the sentence included in the patent sentence group, extracting a patent sentence similar to the invention sentence, and determining a degree of similarity between the invention sentence and the extracted patent sentence.

We also provide a patent evaluation and determination device including: an invention input unit that receives an input of an invention sentence relating to an invention; a keyword extraction unit that performs a syntactic analysis on the input invention sentence in units of words, and then extracts any search keyword in the invention sentence; a patent sentence group extraction unit that extracts a patent sentence group in which the search keyword is contained from a database using the extracted search keyword; and a determination unit that compares the invention sentence and a sentence included in the patent sentence group and determines patentability of the invention sentence, wherein the determination unit determines the patentability of the invention sentence on the basis of a result obtained by multiplying a reciprocal number of an edit distance of the sentence included in the patent sentence group by a length index of the invention sentence and a content rate of the search keyword.

We further provide a patent evaluation and determination program causing a computer to realize: an invention input function of receiving an input of an invention sentence relating to an invention; a keyword extraction function of performing a syntactic analysis on the input invention sentence in units of words, and then extracting any search keyword in the invention sentence; a patent sentence group extraction function of extracting a patent sentence group in which the search keyword is contained from a database using the extracted search keyword; and a determination function of comparing the invention sentence and a sentence included in the patent sentence group and determining patentability of the invention sentence, wherein the determination function includes determining the patentability of the invention sentence on the basis of a result obtained by multiplying a reciprocal number of an edit distance of the sentence included in the patent sentence group by a length index of the invention sentence and a content rate of the search keyword.

Since a search keyword which is the technical field of an invention is extracted by performing a syntactic analysis from an invention sentence and then the invention sentence and a sentence included in an extracted patent sentence group are compared to each other, it is possible to provide a patent evaluation and determination method, a patent evaluation and determination device, and a patent evaluation and determination program that make it possible to determine patentability with a high level of accuracy.

### BRIEF DESCRIPTION OF THE DRAWINGS

Features, advantages, and technical and industrial significance of examples will be described below with reference to the accompanying drawings, in which like numerals denote like elements.

FIG. 1 is a schematic diagram illustrating an example of a process performed by a patent evaluation and determination system.

FIG. 2 is a diagram illustrating an example of a schematic configuration of the patent evaluation and determination system.

FIG. 3 is a diagram illustrating an example of a schematic configuration of a user's terminal device.

FIG. 4 is a diagram illustrating an example of a schematic configuration of a server.

FIG. 5 is an example of a table indicating similarity scores of an invention sentence to similar patents determined by a determination unit.

FIG. 6 is a diagram illustrating an example of an operating sequence of a series of flows until the patentability of an invention sentence is determined in accordance with a request for determination of the invention sentence from the user's terminal device based on the patent evaluation and determination system of the example, and a determination result is transmitted to the user's terminal device.

FIG. 7 is a diagram illustrating an example of an invention sentence input screen displayed by a terminal display unit of the user's terminal device.

FIG. 8 is a diagram illustrating an example of an invention sentence display screen displayed by the terminal display unit of the user's terminal device.

FIG. 9 is a diagram illustrating an example of an invention sentence evaluation display screen displayed by the terminal display unit of the user's terminal device.

FIG. 10 is a diagram illustrating an example of an operating sequence of a series of flows until the patentability of an invention sentence is determined in accordance with a request for determination of the invention sentence from the user's terminal device based on a patent evaluation and determination system according to Modification Example 1, and a determination result is transmitted to the user's terminal device.

FIG. 11 is a diagram illustrating an example of an operating sequence of a series of flows until the patentability of an invention sentence is determined in accordance with a request for determination of the invention sentence from the user's terminal device based on a patent evaluation and determination system according to Modification Example 2, and a determination result is transmitted to the user's terminal device.

### EXPLANATION OF REFERENCES

1 Patent evaluation and determination system
2 User's terminal device
211 Terminal communication unit
212 Terminal storage unit
213 Terminal operating unit
214 Terminal display unit
215 Terminal processing unit
3 Patent sentence provision device
4 Server
411 Server storage unit
412 Search keyword extraction unit
413 Patent sentence group extraction unit
414 Determination unit
415 Generation unit
416 Server processing unit
417 Server communication unit
5 Internet

### DETAILED DESCRIPTION

Hereinafter, a patent evaluation and determination system, a patent evaluation and determination method, and a patent evaluation and determination program according to an aspect of the present disclosure will be described with reference the accompanying drawings. It will, however, be noted that the technical scope of this disclosure is not limited to these examples, but extends to the appended claims and the equivalents thereof.

### Outline of Process of Patent Evaluation and Determination System 1

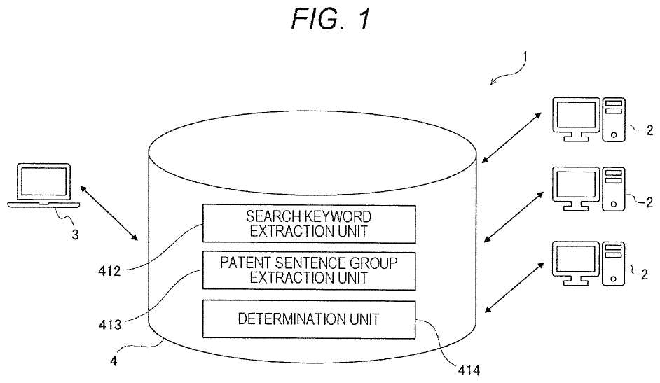

FIG. 1 is a schematic diagram illustrating an example of a process performed by a patent evaluation and determination system 1.

The patent evaluation and determination system 1 includes a plurality of users' terminal devices 2, 2, 2 . . . , a patent sentence database 3, and a server 4 that enables mutual communication between the plurality of users' terminal devices 2 and the patent sentence database 3. The server 4 includes a search keyword extraction unit 412 that receives invention sentences for which evaluation and determination of patentability are desired from the plurality of users' terminal devices 2, and extracts keywords representative of inventions included in the invention sentences as search keywords. The server 4 includes a patent sentence group extraction unit 413 that extracts a similar patent sentence group from the patent sentence database 3 on the basis of the extracted search keywords. The server 4 includes a determination unit 414 that compares the invention sentences received from the plurality of users' terminal devices 2, 2, 2 . . . to the extracted patent sentence group, and determines the patentability of invention sentences. The server 4 transmits evaluation of the patentability determined by the determination unit 413 to the plurality of users' terminal devices 2, 2, 2 . . . .

In this example, patent sentences stored in the patent sentence database 3 are described as search targets, but the server 4 may be configured to download patent sentences from the patent sentence database 3 and extract a similar patent sentence group within the server 4. According to this configuration, since processing can be completed locally, it is possible to increase a processing speed.

The patent sentence database 3 is, for example, a database of a patent office. The database of the patent office may include one or a plurality of offices. Since the databases of the offices of five nations, that is, the US, Europe, Japan, China, and Korea contain approximately 90% of the world's patents, the databases of these five offices may be included to improve the accuracy of determination of patentability.

In addition, invention sentences received by the server 4 from the users' terminal devices 2, 2, 2 . . . may be claims included in publication documents published by the patent office. In addition, the invention sentence may be a sentence relating to the claims before application, or may be the claims scheduled to be amended after examination of application or the like. This invention sentence preferably includes only one invention. That is, it may be written in the form of one claim. Naturally, the user's terminal device 2 can also transmit the invention sentence to the server 4 in the form of plural claims. In that instance, a server processing unit 416 of the server 4 may recognize punctuation for each invention and determine patentability for each invention. In this example, content of the invention before application will be described as an invention sentence, but this disclosure is not limited to this configuration. Schematic configuration of patent evaluation and determination system 1

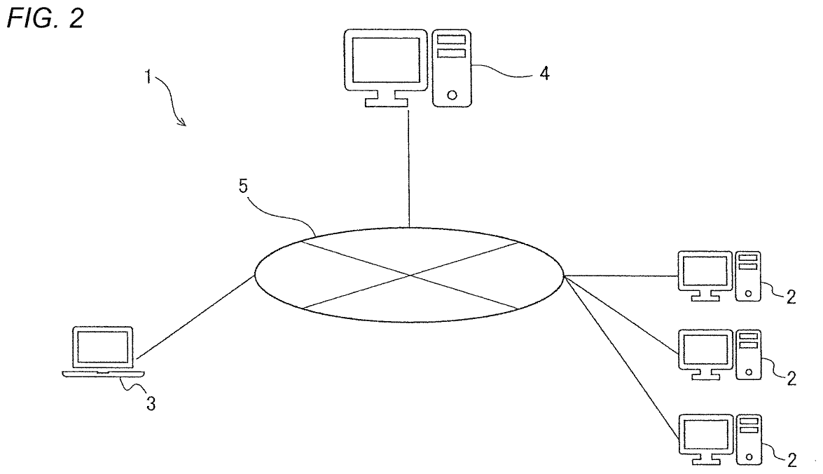

FIG. 2 is a diagram illustrating an example of a schematic configuration of the patent evaluation and determination system 1.

The patent evaluation and determination system 1 includes the plurality of users' terminal devices 2, 2, 2 . . . , the patent sentence database 3, and the server 4. Hereinafter, the plurality of users' terminal devices may simply be called the user's terminal device 2. The users' terminal devices 2, 2, 2 . . . and the server 4 are connected to each other through a communication network such as, for example, the Internet 5. Further, the patent sentence database 3 and the server 4 connect to each other through a communication network such as, for example, the Internet 5. In addition, here, the Internet 5 is illustrated as one network, but when the Internet 5 is composed of a plurality of networks, a gateway (not shown) may be appropriately provided between the networks. A program (for example, a browsing program) executed in the user's terminal device 2 and a program (for example, a management program) executed in the server 4 are based on communication using a communication protocol such as hypertext transfer protocol (HTTP).

Further, since the information that is dealt with is confidential information, connection between the user's terminal device 2 and the server 4 and connection between the patent sentence database 3 and the server 4 need to be configured such that the communication environment of the Internet 5 is excellent in terms of security. In addition, the connection between the user's terminal device 2 and the server 4 and the connection between the patent sentence database 3 and the server 4 can be configured with strengthened security by preparing a dedicated line.

### Schematic Configuration of User's Terminal Device 2

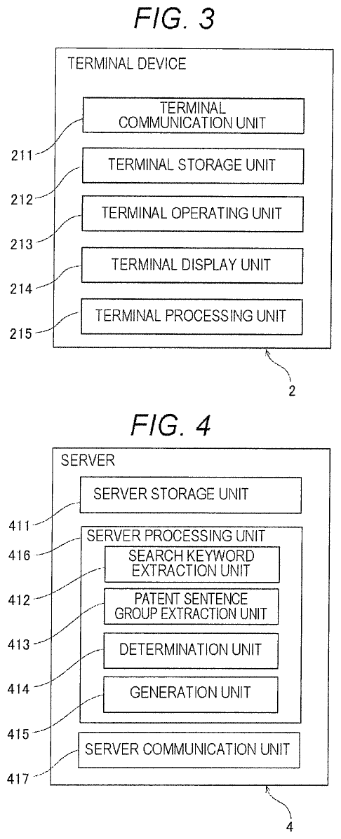

FIG. 3 is a diagram illustrating an example of a schematic configuration of the user's terminal device 2.

The user's terminal device 2 executes connection to a wireless communication network, Web access or the like. Therefore, the user's terminal device 2 includes a terminal communication unit 211, a terminal storage unit 212, a terminal operating unit 213, a terminal display unit 214, and a terminal processing unit 215.

Meanwhile, the user's terminal device 2 is assumed to be a tablet PC or a notebook PC, but this disclosure is not limited thereto. The user's terminal device 2 may have the programs and method applied thereto, and may be, for example, a multi-function cellular phone (a so-called “smartphone”), a cellular phone (a so-called “feature phone”), a portable information terminal (PDA), a portable game console, a portable music player, a tablet terminal or the like.

The terminal communication unit 211 includes a communication interface circuit, and connects the user's terminal device 2 to the Internet 5. The terminal communication unit 211 transmits data supplied from the terminal processing unit 215 through a network to the server 4 or the like. In addition, the terminal communication unit 211 supplies data received from the server 4 or the like through a network to the terminal processing unit 215.

The terminal storage unit 212 includes, for example, a semiconductor memory device. The terminal storage unit 212 stores an operating system program, a driver program, an application program, data or the like used in a process in the terminal processing unit 215. For example, the terminal storage unit 212 stores an input device driver program to control the terminal operating unit 213, an output device driver program to control the terminal display unit 214 or the like as the driver program. In addition, the terminal storage unit 212 stores search conditions input through an operation by a person affiliated with a shop of the terminal operating unit 213, a browsing program to display a registration screen to register feature information, a feature image and the like in the server 4, or the like as the application program. Various programs may be installed in the terminal storage unit 212 using a known setup program or the like from a computer readable portable recording medium such as, for example, a CD-ROM or a DVD-ROM. In addition, the terminal storage unit 212 may temporarily store transient data relating to a predetermined process.

The terminal operating unit 213 may be any device capable of an operation of the user's terminal device 2 and is, for example, a mouse, a touch panel, a key button or the like. A user can select information and input characters or numerals using the release terminal operating unit 213. When the terminal operating unit 213 is operated by a user, a signal corresponding to the operation is generated. The generated signal is transmitted to the terminal processing unit 215.

The terminal display unit 214 may also be any device capable of displaying video, an image or the like and is, for example, a liquid crystal display, an organic electro-luminescence (EL) display or the like. The terminal display unit 214 displays video corresponding to video data supplied from the terminal processing unit 215, an image corresponding to image data or the like.

The terminal processing unit 215 includes one or a plurality of processors and peripheral circuits. The terminal processing unit 215 controls the overall operation of the user's terminal device 2 as a whole, and is, for example, a CPU. The terminal processing unit 215 controls an operation of the terminal communication unit 211, the terminal display unit 214 or the like so that various processes of the user's terminal device 2 are executed in an appropriate procedure on the basis of a program stored in the terminal storage unit 212, the operation of the terminal operating unit 213 or the like. The terminal processing unit 215 executes a process on the basis of a program (such as an operating system program, a driver program, or an application program) stored in the terminal storage unit 212. In addition, the terminal processing unit 215 can execute a plurality of programs (such as application programs) in parallel.

The terminal processing unit 215 has a function of processing screen display information received from outside the user's terminal device 2 as screen display to be capable of being browsed by a user, or a function of converting a process based on operation content of the terminal operating unit 21 from a user into a signal capable of being transmitted outside the user's terminal device 2 and sending the result to the terminal transmission unit 211. These functions are function modules realized by a program executed by a processor included in the terminal processing unit 215. Alternatively, each of these units may be mounted in the user's terminal device 2 as an integrated circuit, a microprocessor, or firmware independent of each other.

### Process of User's Terminal Device 2

The user's terminal device 2 is operated by a user. A user operates the terminal operating unit 213 and inputs an invention sentence for which she or he desire determination of patentability to the user's terminal device 2. The terminal processing unit 215 may correct errors of the invention sentence as necessary, or correct grammar.

In addition, the user's terminal device 2 may be a corporation's terminal device or a network of the entire corporation. Further, the user's terminal device 2 may be a terminal device of the patent office or a network of the entire patent office.

### Configuration of Patent Sentence Database 3

The patent sentence database 3 provides a desired patent sentence group to the server 4 in accordance with a request of the server 4. That is, the patent sentence database 3 extracts a patent sentence group corresponding to search conditions received from the server 4 on the basis of the search conditions, and transmits the result to the server 4. The patent sentence database 3 may search for a patent sentence every time there is a request from the server 4 and transmit the result to the server 4, or the patent sentence database 3 may periodically transmit a patent sentence to the server 4 with respect to a representative search result. Although not shown separately, the patent sentence database 3 may include components such as a processing unit, a communication unit, and a storage unit as a server.

Further, when the server 4 also serves as the patent sentence database 3, the patent sentence database 3 transmits a patent sentence to the server 4 and a storage unit 411 or the like of the server 4 stores the patent sentence. The patent sentence database 3 may transmit a patent sentence to the server 4 in accordance with a request from server 4, or may transmit the patent sentence to the server 4 through a main operation of the patent sentence database 3. In this example, since the server 4 can complete search and determination within the server 4, it is possible to freely adjust a processing speed.

The patent sentence database 3 accumulates and stores newly published laid-open patent publication bulletins or granted patent bulletins. The patent sentence database 3 may itemize in all past patent sentences. For example, the database may be divided into abstracts, the scope of patent claims (claims), full text and the like. In this example, the patent evaluation and determination system 1 performs full-text search and free word search of search keywords included in the claims, as will be described later.

### Schematic Configuration of Server 4

FIG. 4 is a diagram illustrating an example of a schematic configuration of the server 4.

The server 4 includes a server storage unit 411 which is a storage region of the server 4. In addition, the server further includes a server processing unit 416 including a search keyword extraction unit 412, a patent sentence group extraction unit 413, a determination unit 414, and a generation unit 415. Further, the server 4 includes a server communication unit 417 to communicate with the user's terminal device 2 and the patent sentence database 3.

The server storage unit 411 includes, for example, at least one of a semiconductor memory, a magnetic disc device and an optical disc device, and connects to the server 4 through a bus. The server storage unit 411 stores a driver program, an operating system program, an application program, data or the like used in a process performed by the server processing unit 416. For example, the server storage unit 411 stores a communication device driver program or the like to control the server communication unit 417 as the driver program. A computer program may be installed in the server storage unit 411 using a known setup program or the like from a computer readable portable recording medium such as, for example, a CD-ROM or a DVD-ROM. In addition, the server storage unit 411 stores the patent sentence table 411 or the like. Meanwhile, the server storage unit 411 can be equivalent to a storage unit.

The server processing unit 416 includes a search keyword extraction unit 412, a patent sentence group extraction unit 413, a determination unit 414, and a generation unit 415. A function of the server processing unit 416 is a function module realized by a program executed in a processor included in the server processing unit 416. Alternatively, each of these units may be mounted in the server 4 as an integrated circuit, a microprocessor, or firmware independent of each other. Meanwhile, the processing details of the server processing unit 416 will be described later. In addition, the division of components of the server processing unit 416 is an example, and which process is performed by which component is not limited to the description of this example.

The search keyword extraction unit 412 extracts a search keyword to search for a patent sentence group from a plurality of words included in an invention sentence received by the server communication unit 417 from the user's terminal device 2. The search keyword extraction unit 412 divides the received invention sentence into elements. Specifically, small term analysis may be used. That is, the invention sentence is divided into a plurality of word units, and modification relations indicating which words modify which words are extracted. When the invention sentence is an English sentence or the like, a delimiter process of executing division in the priority of a period, a colon, a semicolon, a comma, or a relative pronoun may be performed. A search keyword is extracted from among a plurality of words included in an invention document. For example, a word having a high appearance frequency may be extracted as a search keyword, and an important term as a search keyword from a modification relation between words may be extracted. That is, the search keyword is a term representing a technical field to which an invention sentence input by a user belongs by one word. The search keyword is normally one word, but when it is difficult to narrow down the search keywords to one or the like, a plurality of words may be used. A general technique may be used as the technique in which a search keyword is extracted from an input invention sentence, and there is not limitation on the above method.

In this manner, the patent sentence group extraction unit 413 can extract a patent sentence group easily by extracting an important search keyword in an invention sentence from the invention sentence. In addition, the patent evaluation and determination system 1 can quickly process evaluation and determination of patentability.

The patent sentence group extraction unit 413 extracts a patent sentence group similar to an invention sentence which is input using a search keyword extracted by the search keyword extraction unit 412. In the extraction of a patent sentence group, patent sentences included in the patent sentence database 3 may be searched for simply by keyword search. For example, a patent sentence group in which a search keyword is written in the full text of a patent sentence may be used as a search result, a patent sentence group in which a search keyword is written in all the claims may be extracted as a search result, and a patent sentence group in which a search keyword is written in claim 1 may be extracted as a search result. In this example, a search result in which a search keyword is detected in the full text of a patent sentence is used as a patent sentence group, but this disclosure is not limited to search target points. Since processing becomes simpler as a search target sentence becomes shorter, only claim 1 can be set as a search target for a simple investigation.

The patent sentence group extraction unit 413 may increase the accuracy of a patent sentence group in consideration of the degree of importance of a search keyword from a patent sentence group in which the search keyword is contained. For example, the patent sentence group extraction unit 413 evaluates the degree of importance in a sentence in which a search keyword is included in a patent sentence group, using a TF-IDF method or the like. Here, a patent sentence in which a search keyword appears in the entirety of one patent sentence is assumed to have a low degree of importance, and is assumed to have a high degree of importance in a case where the search keyword appears in only a specific sentence in one patent sentence. The extraction of a patent sentence group for a search keyword using the TF-IDF method or the like may be performed when a user inputs an invention sentence to the terminal device 2 and a search keyword is obtained, and a patent sentence group for a representative search keyword may be stored within the server storage unit 411 in advance.

In this manner, since the patent sentence extraction unit 413 can extract a patent sentence group after consideration of the degree of importance of a search keyword compared to a patent sentence group simply extracted in free word search, the patent evaluation and determination system 1 can perform high-accuracy patent evaluation and determination without performing a useless process. In addition, by extracting a most suitable patent sentence group, the patent evaluation and determination system 1 can quickly process evaluation and determination of patentability.

The determination unit 414 obtains the degree of similarity by comparing an invention sentence to the full text of a sentence included in a patent sentence group (which may be hereinafter described as “the full text of a patent sentence group”) extracted by the patent sentence group extraction unit 413. The determination unit 414 divides the full text of a sentence included in a patent sentence group and an invention sentence into units of minimum sentences (hereinafter called minimum sentences), and obtains the degree of similarity between these minimum sentences. That is, the degree of similarity is obtained by dividing a sentence into minimum sentences in units of components included in an invention sentence, and determining whether the components are disclosed in a patent sentence group. Meanwhile, the determination unit 414 may reflect whether minimum sentences included in an invention sentence are included in one patent sentence or are separately written as a plurality of patent sentences in the degree of similarity. When all the minimum sentences are disclosed in one sentence, the input invention sentence can be determined to lack novelty. In addition, when minimum sentences are written over a plurality of patent sentences, the input patent sentence can be determined to lack inventive step.

In this manner, since the invention sentence and the patent sentence are punctuated in minimum sentences in advance, and then a comparison between the invention sentence and the patent sentence group is performed, the determination unit 414 can perform the determination of similarity between sentences at a smaller scale than in a comparison between the entire invention sentence and the entire patent sentence. Thus, the accuracy of similarity determination performed by the patent evaluation and determination system 1 is improved.

When the degree of similarity is obtained, the determination unit 414 performs scoring on the basis of the following score calculation formula of the degree of similarity. This score calculation is performed on the basis of minimum sentences, but may be configured to obtain an edit distance between the entire invention sentence and the full text of the patent sentence group.

Score calculation formula of degree of similarity=(length penalty of invention sentence)×(content rate in word units of minimum sentences)×(reciprocal number of edit distance in character string level)

The edit distance refers to a distance when there are two character strings and one character string is edited using another. That is, a score is set as 1 when one character is added or deleted, and a score is calculated to be 2 when one character is deleted and added. The reason to use an edit distance in the determination of patentability is because an orthographic variant is absorbed.

In addition, since the edit distance becomes excessively short when comparing excessively short sentences, the length penalty of an invention sentence is a coefficient for correction.

In this manner, the determination unit 414 determines a similarity between an invention sentence and a patent sentence group using the edit distance, and thus can accurately calculate the degree of similarity between sentences in details in units of words or characters. In a normal patent evaluation and determination method, patentability is determined depending on how many similar words are contained. However, the use of the edit distance makes it possible to determine even similarity between the meanings of sentences.

The determination unit 414 obtains the degree of similarity with respect to a patent sentence group as described above, and calculates the determination result of patentability in accordance with the degree of similarity between a patent sentence having a high degree of similarity and an invention sentence. There are various methods of determining final patentability from the degree of similarity, and this disclosure is not limited to these methods.

For example, a score calculated on the basis of an edit distance between minimum sentences of an invention sentence input by a user and minimum sentence of the full text of a patent sentence having a high degree of similarity and a score of the full text of a patent sentence coincident in a distributed representation space are added up, and the score is determined for each of minimum sentences which are components of the full text of the patent sentence. The determination unit 414 normalizes scores by 0 to 1 and outputs the normalized scores as percent.

Further, when ranking performed by the determination unit 414 are divided into four stages of A to D, A is highest in patentability, and B to D decrease in patentability stepwise. The determination of this ranking is calculated by scores with respect to all the elements of an invention sentence.

The determination unit 414 may extract a patent sentence having a high degree of similarity multiple times. In this example, it is configured to extract three similar patent sentences. For example, rank B or higher is set when even one maximum score (maximum degree of similarity in three patent sentences) among components which are minimum sentences of the full text of a similar patent sentence is lower than a predetermined value, and rank A is set when two or more maximum scores are lower than the predetermined value. In addition, rank D is set when the minimum value (every component is written in any of patent sentences) of the maximum score is higher than the predetermined value. In addition, rank B is set when most of scores of components are lower than the predetermined value, and rank C is set when half of the components are higher than that. When the above does not correspond to any of these conditions, the determination unit 414 may impart a rank from the keyword concordance rate of the entire document or the degree of vector similarity.

Patentability is displayed by ranking, whereby a user can simply ascertain the determination of patentability. In addition, it is possible to transmit an accurate patentability determination result to the user's terminal device 2 by lowering a rank when even one patent sentence having a high degree of similarity is extracted.

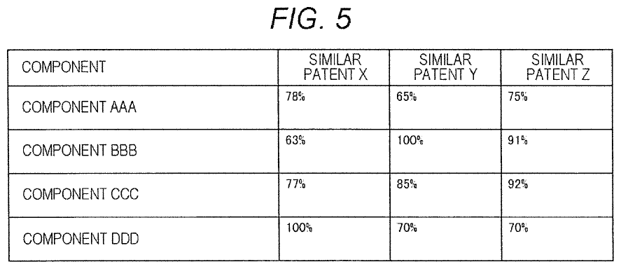

FIG. 5 is an example of a table indicating similarity scores of an invention sentence to similar patents determined by the determination unit 414. The invention sentence is divided into four components, that is, a component AAA, a component BBB, a component CCC, and a component DDD, and the degrees of similarity to a similar patent X, a similar patent Y, and a similar patent Z are shown as percent. According to the above ranking rule, the rank of the invention sentence is set to rank C, and is calculated as a determination result together with the degree of similarity.

The generation unit 415 generates various display screens that are transmitted to the user's terminal device 2. Particularly, a screen including the determination result of patentability determined by the determination unit 414 is generated and transmitted to the user's terminal device 2 through the server communication unit 417.

The determination result of patentability generated by the generation unit 415 may be stored in the server storage unit 411. However, it is preferable to store the information in a transient storage region (memory) without storing content of an invention sentence and the determination result patentability in the server storage unit 411 from the confidential viewpoint of the invention sentence, and transmit the information to the user's terminal device 2. The server storage unit 411 may also take charge of this transient storage region.

The server communication unit 417 includes a communication interface circuit for connecting the server 4 to the Internet 5. The server communication unit 417 receives an invention sentence to obtain the determination of patentability from the user's terminal device 2, and transmits the determination result of the determination unit 414 to the user's terminal device 2. In addition, the server communication unit 417 receives information when a patent sentence is provided from the patent sentence database 3. The server communication unit 417 performs various communications with the user's terminal device 2 as necessary, and the server communication unit 417 performs various communications with a patent sentence providing terminal 3 as necessary.

### Process Performed by Patent Evaluation and Determination System 1

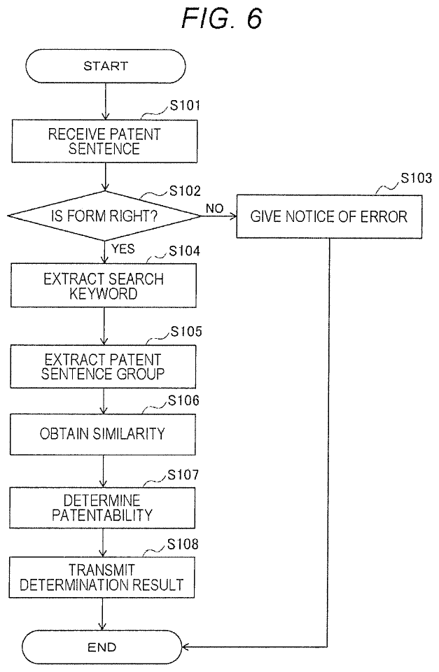

FIG. 6 is a diagram illustrating an example of an operating sequence of a series of flows until the patentability of an invention sentence is determined in accordance with a request for determination of the invention sentence from the user's terminal device 2 based on the patent evaluation and determination system 1 according to this example, and a determination result is transmitted to the user's terminal device 2.

An operating sequence to be described below is executed in cooperation with each element of the server 4 mainly by the server processing unit 416 on the basis of a program stored in the server storage unit 411 in advance. In addition, in the operating sequence to be described below, the server 4 transmits and receives various types of information to and from the user's terminal device 2 through the server communication unit 417.

Initially, the server communication unit 417 of the server 4 receives an invention sentence for which the determination of patentability is desired from the user's terminal device 2 (step S101). This process is started when the server communication unit 417 receives an invention sentence from the user's terminal device 2.

Subsequently, the server processing unit 416 determines whether the invention sentence is described in an appropriate form to determine its patentability (step S102). For example, in this example, an invention sentence needs to be composed of one invention, and thus in a sentence in which there are a plurality of punctuation marks, the server processing unit 416 transmits error information to the user's terminal device 2 through the server communication unit 417. When the invention sentence is described in an erroneous form (NO in step S102), the server processing unit 416 transmits error information to the user's terminal device 2 (step S103) and the process is ended. The server processing unit 416 waits for the reception of an invention sentence having a corrected form or the next invention sentence.

When the invention sentence is described in a correct form (YES in step S102), the server process 416 extracts a term to indicate a technical field to which the invention sentence received from the user's terminal device 2 belongs by one word (step S104). The server processing unit 416 divides the invention sentence into a plurality of word units, extracts a modification relation indicating which words modify which words, and extracts an important term as a search keyword from a modification relation between words.

Subsequently, the server processing unit 416 extracts a patent sentence group similar to the invention sentence which is input using the extracted search keyword (step S105). Specifically, the server processing unit 416 extracts a patent sentence group in which the search keyword is written in the full text of a patent sentence, as a search result, from the patent sentence database 3. In this example, the server processing unit 416 determines to what extent the search keyword is an important word in individual patent sentences, and then extracts patent sentences having a high relativity as the patent sentence group.

The server processing unit 416 compares the full text of the patent sentence group and the invention sentence and obtains the degree of similarity (step S106). Specifically, the server processing unit 416 divides a sentence into minimum sentences in units of components contained in the invention sentence, and determines whether the components are disclosed in the patent sentence group to thereby obtain the degree of similarity. The server processing unit 416 calculates scores of the degree of similarity with respect to the patent sentence contained in each patent sentence group, and extracts three patent sentences having a high score of the degree of similarity. The server processing unit 416 may consider the length of the invention sentence input from the user's terminal device 2, and correct the score of the degree of similarity so that the degree of similarity is produced to be high when the length is excessively short.

Further, the server processing unit 416 determines the patentability of the invention sentence input on the basis of an edit distance between minimum sentences of three extracted patent sentences having a high score of the degree of similarity and minimum sentences of the invention sentence input from the user's terminal device 2 (step S107). The server processing unit 416 calculates the determination of the patentability of the invention sentence which is input to the user's terminal device 2 as a rank. That is, the patentability is evaluated by ranks A to D and is transmitted to the user's terminal device as a determination result (step S108).

### Function of User's Terminal Device 2

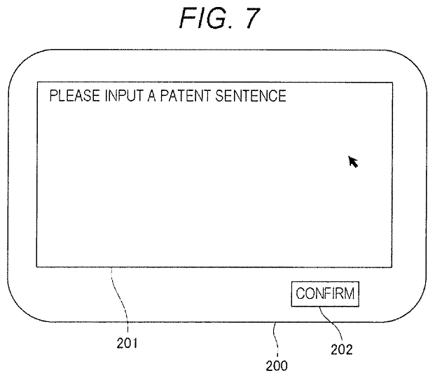

FIG. 7 is a diagram illustrating an example of an invention sentence input screen 200 displayed by the terminal display unit 214 of the user's terminal device 2. The invention sentence input screen 200 is a screen for a user to input an invention sentence using the terminal device 2 and request the determination of its patentability. The invention sentence input screen 200 displays an invention sentence input region 201 which is a region having an input field to input any invention sentence formed therein and a confirmation button 202 to proceed to a confirmation screen to confirm whether the input invention sentence is correctly input.

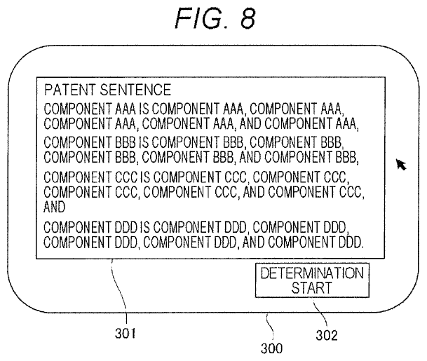

FIG. 8 is a diagram illustrating an example of an invention sentence display screen 300 displayed by the terminal display unit 214 of the user's terminal device 2.

As shown in FIG. 8, the invention sentence display screen 300 is a screen indicating whether the invention sentence input using the terminal device by a user is correctly input. On the invention sentence display screen 300, the input invention sentence is divided and displayed for each component. The example of FIG. 8 schematically shows a screen displayed when an invention sentence composed of four components, that is, a component AAA, a component BBB, a component CCC, and a component DDD is input to the invention sentence input region 201 of FIG. 7, and the confirmation button 202 is pressed by a user through a click operation using a mouse or the like. That is, in the example of FIG. 8, the invention sentence is displayed in a state in which it is divided into invention sentences composed of four components, that is, the component AAA, the component BBB, the component CCC, and the component DDD. The invention sentence display screen 300 displays an invention sentence display region 301 which is a region having a display field to display an invention sentence formed therein and a determination start button 302 to determine the patentability of the invention sentence displayed on the invention sentence display region 301.

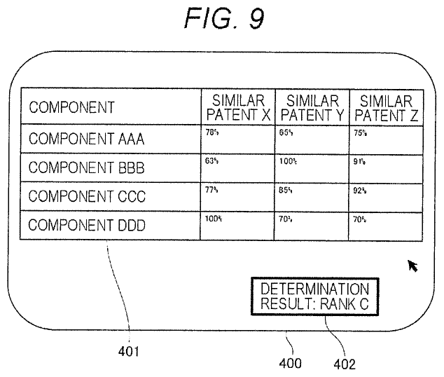

FIG. 9 is a diagram illustrating an example of an invention sentence evaluation display screen 400 displayed by the terminal display unit 214 of the user's terminal device 2. The invention sentence evaluation screen 400 is a screen indicating whether an invention sentence input using the terminal device 2 by a user is correctly input. The invention sentence evaluation screen 400 contains a comparison result display region 401 in which the input invention sentence is divided into components, and results for comparison with patent sentences having a high degree of similarity are shown as percent for each of these components. In addition, the invention sentence evaluation screen 400 contains a rank display region 402 in which the determination results of the patentability of the invention sentence calculated from these comparison results are displayed as ranks A to D. In the example of FIG. 9, the determination result of the patentability of the invention sentence calculated from the comparison results between similar patent sentences and four components, that is, the component AAA, the component BBB, the component CCC, and the component DDD is set as rank C.

As described above, the patent evaluation and determination system 1 can determine the patentability of invention sentences included in requests from the plurality of users' terminal devices 2. Further, since the degree of similarity is calculated using minimum sentences of an invention sentence and the full text of a similar patent sentence as edit distances of characters, the patent evaluation and determination system 1 can determine the patentability of the invention sentence with a higher level of accuracy than in a method of simply determining whether the same word is contained in a patent sentence group.

The patent evaluation and determination system 1 is described as a system in which the user's terminal device 2, the patent sentence data server 3, and the server 4 are independent of each other, but it is possible to exhibit the same effect even in a case where a determination device in which these functions are all present in one place is formed. In addition, these functions can also be provided as a program for installation into the user's terminal device or the like.

It can be readily understood by that those skilled in the art that various changes, substitutions, and modifications can be made without being departing from the spirit and scope of this disclosure. In modification examples to be described below, it can also be understood that our methods, devices and programs can be implemented by a combination of respective modification examples.

### Modification Example 1

The patent sentence group extraction unit 413 of the server processing unit 416 can perform the following processes to improve the accuracy of a patent sentence group. The patent sentence group extraction unit 413 of the server processing unit 416 extracts patent classification (for example, IPC or CPC) imparted to patent sentences of the extracted patent sentence group, creates a histogram, and selects several high-level patent classifications. An AND search with a search keyword is performed again using the selected patent classifications. A search using a search keyword may be simply a free word search, but it is preferable to evaluate to what extent the degree of importance is present in a sentence in which a search keyword is contained in a patent sentence group using the TF-IDF method or the like as described above and then obtain a search result. This search result is updated as a patent sentence group used in comparison with an invention sentence. Through this process, the accuracy of the patent sentence group as an aggregate is improved, and the accuracy of patentability determination is also improved. That is, the patent sentence group extraction unit 413 improves comprehensiveness as an aggregate by using the patent classification, and thus extraction leakage of patent sentences is reduced.

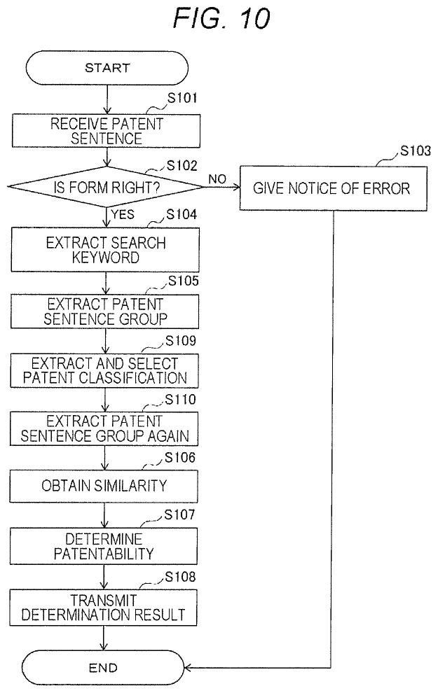

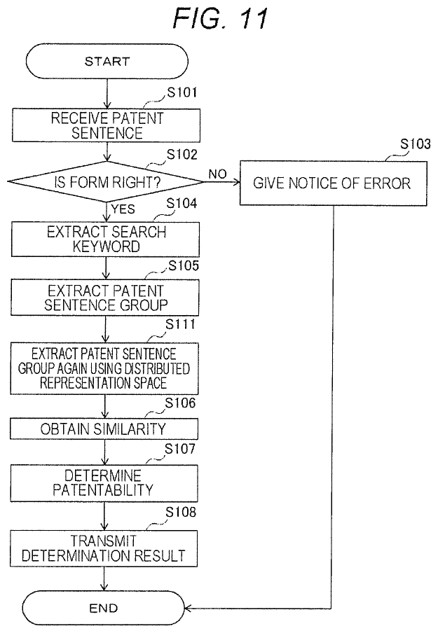

FIG. 10 is a diagram illustrating an example of an operating sequence of a series of flows until the patentability of an invention sentence is determined in accordance with a request for determination of the invention sentence from the user's terminal device 2 based on a patent evaluation and determination system 1 according to Modification Example 1, and a determination result is transmitted to the user's terminal device 2.

In step S105, after a patent sentence group similar to an invention sentence input using the extracted search keyword is extracted, the server processing unit 416 extracts patent classification from the patent sentence group and selects high-level patent classification having a large number of extractions (step S109). Subsequently, the server processing unit 416 extracts a patent sentence group again using the search keyword and the selected high-level patent classification (step S110). A search using this patent classification is changed to OR search when a plurality of patent classifications are included, thereby allowing the patent sentence group to have extension.

### Modification Example 2

The patent sentence group extraction unit 413 of the server processing unit 416 can perform the following processes to improve the accuracy of a patent sentence group. The patent sentence group extraction unit 413 of the server processing unit 416 extracts words approximate to a search keyword in a distributed representation space with respect to the full text of a sentence contained in each patent sentence of the extracted patent sentence group, and updates the extracted result as a patent sentence group used in comparison with the invention sentence. That is, assuming that words used in sentences similar to each other through machine learning have a similar concept, the patent sentence group extraction unit 413 simulates similar words as the same vector. Through this process, vectors of similar keywords can also be recognized to be the same. Through this process, the accuracy of the patent sentence group as an aggregate is improved, and the accuracy of patentability determination is also improved. That is, since the patent sentence group extraction unit 413 extracts patent sentences approximate to the search keyword in a distributed representation space, it is also possible to extract a patent sentence containing words similar to the search keyword.

FIG. 11 is a diagram illustrating an example of an operating sequence of a series of flows until the patentability of an invention sentence is determined in accordance with a request for determination of the invention sentence from the user's terminal device 2 based on a patent evaluation and determination system 1 of Modification Example 2, and a determination result is transmitted to the user's terminal device 2.

In step S105, after a patent sentence group similar to an invention sentence input using the extracted search keyword is extracted, the server processing unit 416 extracts a result narrowed down to a patent group approximate to the search keyword in a distributed representation space as a patent sentence group (step S111).

When the process of Modification Example 2 and the process of Modification Example 1 are combined, accuracy is improved as a patent sentence group when the server processing unit 416 executes step S111 of Modification Example 2 after step S110 of Modification Example 1. Naturally, the server processing unit 416 can also execute step S110 of Modification Example 1 after step S111 of Modification Example 2.

### Modification Example 3

The invention sentence has been described with content of an invention before application defined as the invention sentence, but the patent evaluation and determination system 1 can also be used in the determination of the patentability of the claims contained in patent application after application or the like. In this example, the patent sentence group extraction unit 413 considers an application date of patent application or the like to determine patentability, and extracts a patent sentence group from patent sentences published before the application date. This application date may be an application date stored by the patent sentence database 3, and may be a date directly input to the terminal device 2 by a user.

While preferred examples have been described and illustrated above, it should be understood that these are exemplary and are not to be considered as limiting. Additions, omissions, substitutions, and other modifications can be made without departing from the spirit or scope of this disclosure. Accordingly, our devices, methods and programs are not to be considered as being limited by the foregoing description, and is only limited by the scope of the appended claims.

1-8. (canceled)

9. A patent evaluation and determination method comprising:
an invention input step of receiving an input of an invention sentence relating to an invention;
a keyword extraction step of performing a syntactic analysis on the input invention sentence in units of words, and then extracting any search keyword in the invention sentence;
a patent sentence group extraction step of extracting a patent sentence group in which the search keyword is contained from a database using the extracted search keyword; and
a determination step of comparing the invention sentence and a sentence included in the patent sentence group and determining patentability of the invention sentence,
wherein the determination step includes determining the patentability of the invention sentence on a basis of a result obtained by multiplying a reciprocal number of an edit distance of the sentence included in the patent sentence group by a length index of the invention sentence and a content rate of the search keyword.

10. The patent evaluation and determination method according to claim 9, wherein the determination step includes determining the patentability of the invention sentence on the basis of an edit distance between the invention sentence and the sentence included in the patent sentence group.

11. The patent evaluation and determination method according to claim 9, wherein the determination step includes dividing the invention sentence into components, and then determining the patentability of the invention sentence on the basis of an edit distance from the sentence included in the patent sentence group for each of the divided components.

12. The patent evaluation and determination method according to claim 9, wherein the patent sentence group extraction step includes extracting patent classifications imparted to the patent sentence group, selecting a high-level patent classification having a large number of extractions from among the extracted patent classifications, and extracting the patent sentence group again using the search keyword and the selected high-level patent classification.

13. The patent evaluation and determination method according to claim 9, wherein the patent sentence group extraction step includes extracting a result narrowed down to a patent group approximate to the search keyword in a distributed representation space, as the patent sentence group, from the search keyword and the patent sentence group obtained using the selected high-level patent classification.

14. The patent evaluation and determination method according to claim 9, wherein the determination step includes determining the patentability of the invention sentence by comparing the invention sentence and the sentence included in the patent sentence group, extracting a patent sentence similar to the invention sentence, and determining a degree of similarity between the invention sentence and the extracted patent sentence.

15. A patent evaluation and determination device comprising:
an invention input unit that receives an input of an invention sentence relating to an invention;
a keyword extraction unit that performs a syntactic analysis on the input invention sentence in units of words, and then extracts any search keyword in the invention sentence;
a patent sentence group extraction unit that extracts a patent sentence group in which the search keyword is contained from a database using the extracted search keyword; and
a determination unit that compares the invention sentence and a sentence included in the patent sentence group and determines patentability of the invention sentence,
wherein the determination unit determines the patentability of the invention sentence on a basis of a result obtained by multiplying a reciprocal number of an edit distance of the sentence included in the patent sentence group by a length index of the invention sentence and a content rate of the search keyword.

16. A patent evaluation and determination program causing a computer to realize:
an invention input function of receiving an input of an invention sentence relating to an invention;
a keyword extraction function of performing a syntactic analysis on the input invention sentence in units of words, and then extracting any search keyword in the invention sentence;
a patent sentence group extraction function of extracting a patent sentence group in which the search keyword is contained from a database using the extracted search keyword; and
a determination function of comparing the invention sentence and a sentence included in the patent sentence group and determining patentability of the invention sentence,
wherein the determination function includes determining the patentability of the invention sentence on a basis of a result obtained by multiplying a reciprocal number of an edit distance of the sentence included in the patent sentence group by a length index of the invention sentence and a content rate of the search keyword.

17. The patent evaluation and determination method according to claim 10, wherein the determination step includes dividing the invention sentence into components, and then determining the patentability of the invention sentence on the basis of an edit distance from the sentence included in the patent sentence group for each of the divided components.
